(19) United States
(12) Patent Application Publication
(10) Pub. No.: US 2025/0144592 A1
(43) Pub. Date: May 8, 2025

(54) APPARATUS AND METHODS FOR INSTALLATION AND REMOVAL OF CATALYST CARRIERS

(71) Applicant: JOHNSON MATTHEY DAVY TECH NOLOGIES LIMITED, London (GB)

(72) Inventor: Henry Arthur CLAXTON, London (GB)

(21) Appl. No.: 18/833,745

(22) PCT Filed: Feb. 17, 2023
(86) PCT No.: PCT/GB2023/050360

§ 371 Date: Jul. 26, 2024

(30) Foreign Application Priority Data
Feb. 18, 2022 (GB) 2202226.3

(51) Int. Cl. B01J 19/24; B01J 19/32

(52) U.S. Cl. CPC B01J 19/2415; B01J 19/32; B01J 2219/00018

(57) ABSTRACT

Apparatus and methods for installation and removal of catalyst carriers in tubular reactors which utilise a support unit. The support unit is installable within a reactor tube together with a plurality of catalyst carriers. The support unit comprises at least one engaging portion for engaging an inner surface of the reactor tube to create a frictional engagement between the support unit and the reactor tube. The magnitude of the frictional engagement is sufficient for the support unit to support a static load of two or more catalyst carriers so as to hold two or more catalyst carriers in place within the reactor tube.

The present disclosure relates to apparatus and methods for installation and removal of catalyst carriers in tubular reactors.

### BACKGROUND

Conventional, so-called fixed-bed tubular, reactors comprise a reactor shell containing a plurality of tubes, which are usually cylindrical, and which are usually directly filled with catalyst particles. In use, a heat-transfer medium flows through the shell of the reactor outside these tubes and thereby adjusts the temperature of the catalyst in the tubes by heat exchange across the tube wall. Thus, where the reaction is an exothermic reaction, the heat-transfer medium will allow heat to be removed from the catalyst and where the reaction is an endothermic reaction, the heat-transfer medium will provide heat to the catalyst.

For some reactions, the heat effects of the reaction are moderate such that they are either not problematic or they can be readily managed. In some cases, the heat effects are sufficiently small that large-diameter tubes may be used. This has the benefit that there is a large volume of catalyst within the tube.

However, for more exothermic or endothermic reactions it is necessary that there is efficient heat transfer via the tube wall to the heat-transfer medium to enable the conditions within the reactor to be controlled in order to maintain a stable operating temperature to avoid detrimental effects occurring. Such effects, for exothermic reactions, may include side reactions taking place, damage to the catalyst such as by sintering of the catalytic active sites, and, in a worst case, thermal runaway. Detrimental effects for endothermic reactions may include quenching of the reaction.

To achieve the desired efficiency, the surface area of the tube wall per unit length has to be maximised. This has, in the past, been achieved by installing a greater number of smaller-diameter tubes. In some reactions, the size restriction means that the tubes are only of the order of about 15 to 40 mm internal diameter. However, the use of this multiplicity of tubes increases the cost and complexity of the reactor.

Thus, in an attempt to mitigate these problems an alternative approach has been developed, in particular for more exothermic or endothermic reactions, in which the catalyst is not directly packed into the reactor tubes but is instead contained in a plurality of catalyst carriers that are configured to sit within the reactor tube.

A first type of such a catalyst carrier is described in WO2011/048361. This arrangement seeks to optimise heat transfer at the tube wall such that larger tubes and larger volumes of smaller catalyst particles can be used, even for more exothermic or endothermic reactions. The catalyst carrier described in WO2011/048361 comprises an annular container for holding catalyst in use. The container has a perforated inner wall defining a tube, a perforated outer wall, a top surface closing the annular container and a bottom surface closing the annular container. The surface closing the bottom of the tube is formed by the inner wall of the annular container. A skirt extends upwards from the perforated outer wall of the annular container from a position at or near the bottom surface of the container to a position below the location of a seal. A seal is located at or near the top surface and extends from the container by a distance which extends beyond an outer surface of the skirt.

A second type of such a catalyst carrier is described in WO2012/136971. In this arrangement, the catalyst carrier comprises a container for holding a monolith catalyst in use, said container having a bottom surface closing the container and a skirt extending upwardly from the bottom surface of said container to a position below the location of a seal and spaced therefrom, said skirt being positioned such that there is a space between an outer surface of the monolith catalyst and the skirt; and a seal located at or near a top surface of the monolith catalyst and extending from the monolith catalyst by a distance which extends beyond an outer surface of the skirt.

A third type of such a catalyst carrier is described in WO2016/050520. In this arrangement, the catalyst carrier comprises a container for holding catalyst in use. The container has a bottom surface closing the container and a top surface. A carrier outer wall extends from the bottom surface to the top surface and a seal extends from the container by a distance which extends beyond the carrier outer wall. The carrier outer wall has apertures located below the seal.

With catalyst carriers, for example of the types mentioned above, the seal that extends beyond the container serves at least two functions.

First, the seal acts to guide reactant(s) correctly through the catalyst carriers and substantially prevents bypass flow of the reactant(s). For example, in a tubular reactor with downflow, reactant(s) flow downwardly through the reactor tube and thus first contact a top surface of the uppermost catalyst carrier of a stacked formation of catalyst carriers. The seal of each catalyst carrier extends outwardly from the container and is sized to make a sealing contact with an inner surface of the bore of the reactor tube. This sealing contact substantially blocks the passage of the reactant(s) around the side of the catalyst carrier. Consequently, the reactant(s) are guided to flow through an interior of the container of the catalyst carrier where they contact the catalyst contained therein.

Secondly, the seal acts to physically support the catalyst carrier within the bore of the reactor tube. For example, the seal of each catalyst carrier extends outwardly from the container and is sized to be deformed when inserted into the reactor tube such that a residual frictional engagement of the catalyst carrier with the inner surface of the reactor tube is obtained. The use of such seals makes the catalyst carrier self-supporting, i.e. the residual frictional engagement is sufficiently strong to maintain the position of the catalyst carrier within the reactor tube without external support.

In a tubular reactor there may be hundreds or possibly thousands of such catalyst carriers and each reactor tube may contain many catalyst carriers, for example up to 80 or more in a stacked formation. Consequently, the insertion force required in install the catalyst carriers into each reactor tube can be high. In particular, the required insertion force scales with the number of catalyst carriers already inserted into the reactor tube-since inserting each catalyst carrier requires all of the already inserted catalyst carriers to be pushed further along the reactor tube. As such, the catalyst carriers must be carefully designed in terms of materials and dimensions to withstand high crushing forces to ensure that they are not damaged during installation into the reactor tubes.

Furthermore, for optimal performance of the catalyst carriers and the reactor, loading should ensure proper alignment of the catalyst carriers within the reactor tubes. In heat-exchange tubular reactors, it is also desirable to place the catalyst carriers in the heat-exchange zone so that uncontrolled heating or cooling is prevented.

An object of the present disclosure is to provide apparatus and methods for the loading and unloading of catalyst carriers that address these matters.

### SUMMARY OF THE DISCLOSURE

In a first aspect of the present disclosure there is provided a method of installing catalyst carriers into a reactor tube of a tubular reactor, the tubular reactor being of a type comprising a plurality of reactor tubes that extend between an upper tube sheet and a lower tube sheet, with a heat-exchange zone being provided between the upper tube sheet and the lower tube sheet;
the method comprising the steps of:
i) providing a plurality of catalyst carriers;
ii) providing a support unit comprising at least one engaging portion for engaging an inner surface of the reactor tube;
iii) inserting the support unit into a first, preferably upper, end of the reactor tube to create a frictional engagement between the at least one engaging portion of the support unit and an inner surface of the reactor tube;
iv) inserting catalyst carriers into the first end of the reactor tube to push the support unit along the reactor tube towards a second, preferably lower, end of the reactor tube into an installed position;
wherein a magnitude of the frictional engagement of the at least one engaging portion of the support unit enables the support unit to support a static load of two or more catalyst carriers so as to hold two or more catalyst carriers in place within the reactor tube when additional catalyst carriers are not being inserted into the first end of the reactor tube.

Advantageously, the support unit functions to provide physical support to the catalyst carriers in the reactor tube, in particular during the process of installing the catalyst carriers into the reactor tube. The support provided by the support unit means that the seal of each catalyst carrier is no longer required to support as much, or any, of the weight of the catalyst carrier, so may be made of thinner and/or more flexible materials. This in turn means that the insertion force required to insert each catalyst carrier into the reactor tube, and then push the catalyst carrier along the reactor tube into its installed position, can be reduced.

The use of the support unit may also enable the use of non-self-supporting catalyst carriers, i.e. catalyst carriers that slide down a reactor tube solely under the action of gravity without the application of any additional external force.

Also advantageously, the reduced insertion force for each individual catalyst carrier means that the maximum total insertion force required to push a stack of the catalyst carriers along the reactor tube during the filling of the reactor tube can be reduced compared to inserting a stack of catalyst carriers that have seals that are self-supporting.

The reduced force required to insert the catalyst carriers into the reactor tubes may enable the use of catalyst carriers that have a reduced crush strength compared to known catalyst carriers. Consequently, the catalyst carriers may be formed with reduced part thicknesses, for example having reduced plate thicknesses for walls and tubular elements of the container of the catalyst carriers. Advantageously, the use of reduced part thicknesses may reduce the weight and cost of the catalyst carriers and at the same time increase the internal volume able to contain catalyst. Further, fewer resources may be required to manufacture the catalyst carrier increasing the sustainability of the process.

The physical support provided by the support unit may enable the configuration of the seal(s) to be altered such that the seal design is focused on obtaining the necessary quality of fluid seal to prevent or limit bypass of the reactant(s) around the container body of the catalyst. For example, the diameter of the seal(s) may be reduced and/or the stiffness of the seal(s) may be reduced and/or the material thickness of the seal(s) may be reduced and/or the material of the seals may be altered.

In addition, a more flexible seal may be more impervious to damage, such as impact damage that may occur during manual handling of the catalyst carriers prior to installation.

Advantageously, the use of the support unit may enable individual reactor tubes to be filled and/or emptied of catalyst carriers more easily than with prior designs of tubular reactor. For example, the catalyst carriers may be configured to slide out of the reactor tube under the action of gravity once the support unit is removed.

The support unit and/or catalyst carriers may be inserted into the first end of the reactor tube by manual force or by using a tool, for example a mechanical ram to assist in pushing the support unit and/or catalyst carriers into the reactor tube.

The magnitude of the frictional engagement may be selected to enable the support unit to support the static load of three or more, optionally five or more, optionally ten or more, optionally twenty or more, optionally fifty or more catalyst carriers, so as to hold three or more, optionally five or more, optionally ten or more, optionally twenty or more, optionally fifty or more catalyst carriers in place within the reactor tube when additional catalyst carriers are not being inserted into the first end of the reactor tube.

The magnitude of the frictional engagement may be selected to enable the support unit to slide along the reactor tube under a dynamic loading imparted on the support unit via the catalyst carriers as additional catalyst carriers are inserted into the first end of the reactor tube.

A magnitude of a frictional engagement of each individual catalyst carrier with the reactor tube, when inserted in the reactor tube, may be less than a weight of that catalyst carrier such that the catalyst carrier will slide down the reactor tube under its own weight unless supported by an external object.

The support unit may be pushed along the reactor tube into its installed position that may be in proximity with the second end of the reactor tube, and preferably level with the lower tube sheet.

The method may comprise inserting a single support unit in the reactor tube and pushing the single support unit towards the second end of the reactor tube using a single stack of catalyst carriers that are inserted individually or in sets into the first end of the reactor tube. Optionally the single stack of catalyst carriers may extend from the single support unit to, or into proximity with, the first end of the reactor tube.

The support unit may support an entire tube-full of catalyst carriers. For example, a single support unit may be installed at or towards the bottom of a reactor tube and catalyst carriers may be supported on top of the support unit in a single stack. For example, 60, 70, 80 or more catalyst carriers may be supported on top of one support unit.

Alternatively, the method may comprise:
a) inserting a first support unit in the reactor tube and pushing the first support unit towards the second end of the reactor tube using a first stack of one or more catalyst carriers that are inserted individually or in sets into the first end of the reactor tube;
b) inserting a second support unit in the reactor tube and pushing the second support unit, the first stack of one or more catalyst carriers and the first support unit towards the second end of the reactor tube using a second stack of one or more catalyst carriers that are inserted individually or in sets into the first end of the reactor tube.

The method may further comprise, likewise to step b), inserting third, fourth or greater numbers of support units by use of third, fourth or greater numbers of stacks of one or more catalyst carriers.

Each support unit may support a partial tube's worth of catalyst carriers. For example, each support unit may support a set of 10 catalyst carriers positioned on top of the support unit and the reactor tube may comprise 2 to 8 or more support units.

The magnitude of the frictional engagement of the at least one engaging portion of the support unit with the inner surface of the reactor tube may be varied by adjustment of the at least one engaging portion of the support unit.

Adjustment of the at least one engaging portion of the support unit may be carried out before or during insertion of the support into the reactor tube. Optionally the at least one engaging portion may be adjusted to calibrate the magnitude of the frictional engagement to a characteristic of the reactor tube.

Additionally or alternatively, adjustment of the at least one engaging portion of the support unit may be carried out when the support unit is installed in its installed position in the reactor tube. Optionally the at least one engaging portion may be adjusted to calibrate the magnitude of the frictional engagement to a characteristic of the reactor tube.

The characteristic of the reactor tube may be one or more of an inner diameter of the reactor tube, a surface roughness of the reactor tube, and an ovality of the reactor tube.

Varying the magnitude of the frictional engagement may be carried out from a location above and/or below the support unit.

Varying the magnitude of the frictional engagement may be carried out using an adjustment tool that is applied to the support unit via the first end and/or the second end of the reactor tube.

The method may further comprise varying the magnitude of the frictional engagement of the support unit with the inner surface of the reactor tube to lock the support unit relative to the reactor tube.

Advantageously, adjustment of the at least one engaging portion of the support unit enables the support unit to be tailored to the requirements of an individual reactor tube. It also enables a support unit to have different levels of frictional engagement with the reactor tube at different points in time.

The or each support unit preferably does not contain any catalyst material.

The method may further comprise uninstalling the catalyst carriers from the reactor tube by:
v) removing the or each support unit from the reactor tube;
vi) sliding the catalyst carriers out of the reactor tube, preferably solely under the action of gravity.

The or each support unit may be removed from one end of the reactor tube by being pushed out using one or more additional catalyst carriers that are inserted into an opposite end of the reactor tube.

Alternatively, the or each support unit may be removed from the reactor tube by decreasing the magnitude of the frictional engagement of the at least one engaging portion of the support unit with the inner surface of the reactor tube and allowing the support unit to slide out of the reactor tube, preferably solely under the action of gravity.

In a second aspect of the present disclosure there is provided a support unit for a reactor tube of a tubular reactor, the tubular reactor being of a type comprising a plurality of reactor tubes that extend between an upper tube sheet and a lower tube sheet, with a heat-exchange zone being provided between the upper tube sheet and the second tube sheet;
the support unit being installable within the reactor tube together with a plurality of catalyst carriers;
the support unit comprising at least one engaging portion for engaging an inner surface of the reactor tube to create a frictional engagement between the support unit and the reactor tube;
the magnitude of the frictional engagement being sufficient for the support unit to support a static load of two or more catalyst carriers so as to hold two or more catalyst carriers in place within the reactor tube.

The magnitude of the frictional engagement may be sufficient for the support unit to support the static load of three or more, optionally five or more, optionally ten or more, optionally twenty or more, optionally fifty or more catalyst carriers, so as to hold three or more, optionally five or more, optionally ten or more, optionally twenty or more, optionally fifty or more catalyst carriers in place within the reactor tube.

The support unit may be configured to support a plurality of catalyst carriers stacked above and/or below the support unit. Optionally the plurality of catalyst carriers may form a stack of catalyst carriers that directly engages an upper or lower end of the support unit.

The at least one engaging portion may be ‘self-locking’ wherein the frictional engagement with the bore of the reactor tube is increased when a force is applied to try and push the support unit downwards in the bore of the reactor tube.

The at least one engaging portion may be adjustable for varying a magnitude of the frictional engagement of the support unit with the inner surface of the reactor tube.

The at least one engaging portion may be reversibly adjustable for selectively increasing and decreasing the frictional engagement of the support unit with the inner surface of the reactor tube.

The at least one engaging portion may be configured to be adjustable before or during insertion of the support unit into the reactor tube.

The at least one engaging portion may be configured to be adjustable when the support unit is installed in its installed position in the reactor tube.

The at least one engaging portion may be configured to be adjustable from a location above and/or below the support unit.

The at least one engaging portion may comprise an adjustment mechanism that is configured to be operated by an adjustment tool that is applied to the support unit via an end of the reactor tube.

The at least one engaging portion may be configured to be pressed against the inner surface of the reactor tube.

The at least one engaging portion may comprise 1 or more, optionally 2 or more, optionally 4 or more, optionally 6 or more engaging portions. The at least one engaging portion may comprise one or more pairs of engaging portions. Each pair may comprise opposed engaging portions that extend outwardly from opposite sides of the support unit. The support unit may be provided with two, four, six or more pairs of engaging portions.

The at least one engaging portion may comprise an adjustment mechanism that is operable to adjust a length, an angle of projection, and/or a length of projection of the at least one engaging portion, and/or to adjust a force applied by the at least one engaging portion against the inner surface of the reactor tube, and/or to adjust a surface area of engagement of the at least one engaging portion against the inner surface of the reactor tube.

The at least one engaging portion may comprise one or more arms, wings, flanges, rims, projections or skirts that project from a body of the support unit. In some embodiments the at least one engaging portion may comprise an expandable or inflatable, for example by hydraulics or pneumatics, device.

The support unit may comprise a resilience for pressing the one or more arms, wings, flanges, rims, projections or skirts against the inner surface of the bore of the reactor tube; optionally wherein the resilience is a variable resistance; optionally wherein the resilience comprises one or more spring elements.

The support unit may comprise a mechanical or electrical mechanism for moving the at least one engaging portion. The mechanical or electrical mechanism may be configured to convert a linear or rotary action of an adjustment tool into a linear and/or a radial and/or an angular movement of the at least one engaging portion.

Additionally or alternatively, the support unit may comprise an hydraulic or pneumatic mechanism for moving the at least one engaging portion. For example, the at least one engaging portion may be moved radially inwards and outwards by varying a pressurisation of an hydraulic or pneumatic bladder associated with the at least one engaging portion.

At least one end of the support unit may be configured to engage with one of the catalyst carriers to maintain alignment of the catalyst carriers in the reactor tube.

The or each support unit preferably does not contain any catalyst material.

The support unit may comprise an inner channel for transfer of liquids and gases through the support unit. Advantageously, the inner channel may ensure that the presence of the support unit does not interfere with liquid and gas flow during operation of the reactor tube.

The materials and any contents of the support unit may be selected to be non-reactive with respect to the intended process conditions of the tubular reactor.

In a third aspect of the present disclosure there is provided a support unit for a reactor tube of a tubular reactor, the tubular reactor being of a type comprising a plurality of reactor tubes that extend between an upper tube sheet and a lower tube sheet, with a heat-exchange zone being provided between the upper tube sheet and the second tube sheet;
the support unit being installable within the reactor tube together with a plurality of catalyst carriers;
the support unit comprising at least one engaging portion for engaging an inner surface of the reactor tube to create a frictional engagement between the support unit and the reactor tube;
wherein the at least one engaging portion is adjustable for varying a magnitude of the frictional engagement of the support unit with the inner surface of the reactor tube.

The at least one engaging portion may be reversibly adjustable for selectively increasing and decreasing the frictional engagement of the support unit with the inner surface of the reactor tube.

The at least one engaging portion may be configured to be pressed against the inner surface of the reactor tube.

The at least one engaging portion may comprise an adjustment mechanism that is operable to adjust a length, an angle of projection, and/or a length of projection of the at least one engaging portion, and/or to adjust a force applied by the at least one engaging portion against the inner surface of the reactor tube, and/or to adjust a surface area of engagement of the at least one engaging portion against the inner surface of the reactor tube.

The at least one engaging portion may comprise one or more arms, wings, flanges, rims, projections or skirts that project from a body of the support unit.

The support unit may comprise a resilience for pressing the one or more arms, wings, flanges, rims, projections or skirts against the inner surface of the bore of the reactor tube.

The resilience may be a variable resistance. The resilience may comprise one or more spring elements.

The support unit may comprise a mechanical or electrical mechanism for moving the at least one engaging portion; and optionally the mechanical or electrical mechanism may be configured to convert a linear or rotary action of an adjustment tool into a linear and/or a radial and/or an angular movement of the at least one engaging portion.

In a fourth aspect of the present disclosure there is provided a tubular reactor comprising a plurality of reactor tubes that extend between an upper tube sheet and a lower tube sheet, with a heat-exchange zone being provided between the upper tube sheet and the lower tube sheet, the or each reactor tube containing:
i) one or more support units that each comprise at least one engaging portion frictionally engaging an inner surface of the reactor tube; and
iii) one or more stacks of catalyst carriers that are supported in place by the one or more support units.

Each support unit may support two or more catalyst carriers, optionally three or more, optionally five or more, optionally ten or more, optionally twenty or more, optionally fifty or more catalyst carriers.

A frictional engagement of each individual catalyst carrier with the reactor tube in which it is contained may be less than the weight of that catalyst carrier.

The or each reactor tube may contain two or more support units.

The at least one engaging portion of the one or more support units may have been adjusted to vary a magnitude of the frictional engagement with the inner surface of the reactor tube in which it is contained.

The at least one engaging portion of the one or more support units may have been adjusted to calibrate the magnitude of the frictional engagement to a characteristic of the reactor tube, for example an inner diameter of the reactor tube, a surface roughness of the reactor tube, and/or an ovality of the reactor tube.

The or each support unit may be as described in any of the above aspects.

Advantageously, the use of the support units in the reactor tubes may obviate the need to provide a support, such as a grid, mesh or plate, at the bottom of the reactor tubes as part of the tubular reactor. However, the support units may also be used in combination with a support, such as a grid, mesh or plate, at the bottom of the reactor tubes.

Advantageously, the support unit may also function to prevent a catalyst carrier containing catalyst being located at the level of the lower tube sheet. Instead, all of the catalyst carriers containing catalyst may be located within the heat-exchange zone. This may result in a more optimised performance of the tubular reactor, since heat exchange with all of the catalyst carriers is facilitated.

In a fifth aspect of the present disclosure there is provided a kit of parts for installation in a reactor tube of a tubular reactor being of a type comprising a plurality of reactor tubes that extend between an upper tube sheet and a lower tube sheet, with a heat-exchange zone being provided between the upper tube sheet and the lower tube sheet, the kit of parts comprising one or more support units and a plurality of catalyst carriers;
wherein the one or more support units are installable within the reactor tube and each support unit comprises at least one engaging portion for engaging an inner surface of the reactor tube to create a frictional engagement between the support unit and the reactor tube of a magnitude sufficient to support the weight of two or more of the catalyst carriers; and
wherein the catalyst carriers are installable within the reactor tube and each catalyst carrier comprises a seal for engaging the inner surface of the reactor tube to produce a frictional engagement between the catalyst carrier and the reactor tube that is insufficient to support the weight of the catalyst carrier within the reactor tube.

The at least one engaging portion of each support unit may create a frictional engagement between the support unit and the reactor tube of a magnitude sufficient to support the weight of three or more, optionally five or more, optionally ten or more, optionally twenty or more, optionally fifty or more catalyst carriers.

The one or more support units preferably do not contain any catalyst material and the catalyst carriers preferably contain a catalyst material.

The kit of parts may comprise 1 to 20 support units and 20 to 200 catalyst carriers.

The present support units, tubular reactors, methods and kit of parts may usefully be used for a wide range of processes. Examples of suitable uses include processes and reactors for exothermic reactions such as reactions for the production of methanol, reactions for the production of ammonia, methanation reactions, hydrogenation reactions, shift reactions, oxidation reactions such as the formation of maleic anhydride and ethylene oxide reactions and the like. A particularly preferred use is in processes and reactors for performing the Fischer-Tropsch reaction.

Endothermic reactions such as pre-reforming, dehydrogenation and the like may also be carried out in conjunction with the present support units, tubular reactors and methods.

The catalyst carriers of the present disclosure may be filled or partially filled with any catalyst suitable for the intended reaction. The catalyst may be provided as catalyst particles or a catalyst monolith. The catalyst may be provided as a single bed of catalyst or multiple beds of catalyst. The catalyst carrier may be configured to promote axial and/or radial flow through the catalyst. In some embodiments the catalyst carrier may be configured to preferentially promote radial flow through the catalyst.

The support unit and catalyst carrier of the present disclosure may be formed of any suitable material. Such material will generally be selected to withstand the operating conditions of the tubular reactor. The support unit and the catalyst carrier may be fabricated from carbon steel, aluminium, stainless steel, other alloys or any material able to withstand the reaction conditions.

The catalyst carrier of the present disclosure may advantageously allow catalyst to be used in medium to highly exothermic or endothermic reactions. The catalyst carrier may allow the use of large reactor tubes leading to large weight and cost reductions for a reactor of a given capacity.

### BRIEF DESCRIPTION OF THE DRAWINGS

Embodiments of the present disclosure will now be described, by way of example only, with reference to the accompanying drawings, in which:

FIG. 1 is a schematic view of a tubular reactor;

FIG. 2 is a schematic representation of a first arrangement comprising a support unit and a plurality of catalyst carriers in a reactor tube;

FIG. 3 is a schematic representation of a second arrangement comprising a plurality of support units and a plurality of catalyst carriers in a reactor tube;

FIG. 4 is a cross-sectional view of a support unit installed in a reactor tube;

FIG. 5 is a bottom end view of the support unit and reactor tube of FIG. 4;

FIG. 6 is a schematic representation of another support unit installed in a reactor tube;

FIG. 7 is a schematic representation of another support unit installed in a reactor tube;

FIG. 8 is a schematic representation of another support unit installed in a reactor tube;

FIG. 9 is an exploded perspective view of a catalyst carrier;

FIG. 10 is a perspective view of the catalyst carrier of FIG. 9; and

FIG. 11 is a cross-sectional view of the catalyst carrier of FIGS. 9 and 10.

### DETAILED DESCRIPTION

In the following, aspects and embodiments of the present disclosure will be described, by way of example only, with reference to a vertically orientated tubular reactor having a plurality of vertical reactor tubes extending between an upper tube sheet and a lower tube sheet. However, it will be understood that the present disclosure may also be applied to other configurations of tubular reactor that may adopt other orientations.

Additionally, in this specification any reference to orientation; for example, terms such as top, bottom, upper, lower, above, below and the like are used with regard to the orientation of the parts as illustrated in the drawings being referenced but are not to be seen as restrictive on the potential orientation of such parts in actual use. For example, a part described as being orientated vertically may also be orientated horizontally in use.

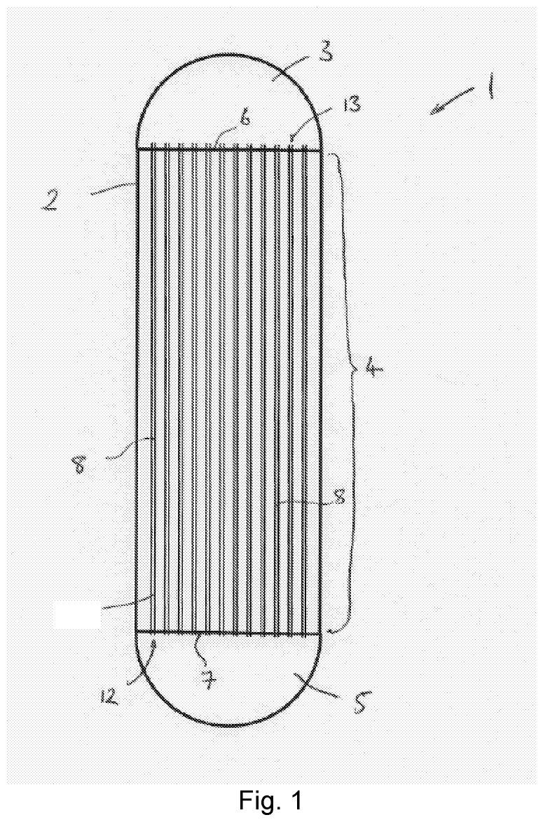

FIG. 1 shows a typical layout of a tubular reactor 1 of the present disclosure. The tubular reactor 1 comprises a housing 2. The interior of the housing may be divided into a head space 3, a heat-exchange zone 4 and a footer space 5 by two tube sheets—an upper tube sheet 6 and a lower tube sheet 7. The upper tube sheet 6 separates the head space 3 from the heat-exchange zone 4. The lower tube sheet 7 separate the footer space 5 from the heat-exchange zone 4.

A plurality of reactor tubes 8 extend between the upper tube sheet 6 and the lower tube sheet 7. A large number of reactor tubes 8 may be provided, for example between 20 and 5000 reactor tubes 8 may be present. Each reactor tube 8 may have, for example, an internal diameter of between 20 and 150 mm. In some embodiments the internal diameter may be about 85 mm.

Each reactor tube 8 is intended to be filled or substantially filled with a stacked arrangement of catalyst carriers 10. The head space 3 may provide access to an upper end of the reactor tubes 8 to allow loading of the catalyst carriers 10 into the reactor tubes 8. An access opening may be provided in the housing 2 to allow access to the head space 3. The access opening may, for example, be a manhole or other access panel that can be selectively opened and closed. The footer space 5 may provide access to the lower end of the reactor tubes 8 to allow unloading of the catalyst carriers 10 from the reactor tubes 8.

According to the present disclosure one or more support units 20 may be utilised in at least one reactor tube 8 to support and retain the catalyst carriers 10 within the bore of the reactor tube 8. Optionally, each of the reactor tubes 8 present in the tubular reactor 1 utilise one or more of the support units 20 to support and retain the catalyst carriers 10 in each reactor tube 8.

In the following a support unit 20 will be described in detail. It will be appreciated that a single tubular reactor 1 may use many such support units 20.

The support unit 20 is installable within the reactor tube 8. The support unit 20 may be fully contained within the reactor tube, i.e. without any part protruding from the reactor tube. Alternatively, a portion of the support unit 20 may be protrude from the reactor tube.

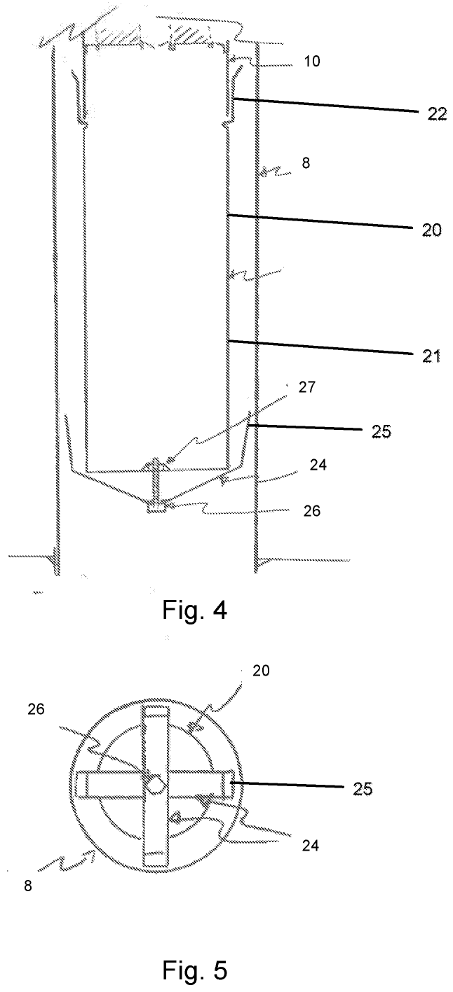

As will be discussed further below with reference to FIGS. 4 and 5, the support unit 20 comprises at least one engaging portion 24 for engaging an inner surface of the reactor tube 8 to create a frictional engagement between the support unit 20 and the reactor tube 8.

The support unit 20 is installed by inserting the support unit 20 into a first, preferably upper, end of the reactor tube 8 to create the frictional engagement between the at least one engaging portion 24 and an inner surface of the reactor tube 8. Then one or more catalyst carriers 10 may be inserted into the first end of the reactor tube 8 to push the support unit 20 along the reactor tube 8 towards a second, preferably lower, end of the reactor tube 8 into its installed position.

The magnitude of the frictional engagement is sufficient for the support unit 20 to support a static load of two or more catalyst carriers 10 so as to hold two or more catalyst carriers 10 in place within the reactor tube 8. Optionally, the magnitude of the frictional engagement may be sufficient to support a larger number of catalyst carriers 10, e.g. three or more, five or more, ten or more, twenty or more, or fifty or more catalyst carriers.

The support unit 20 may be installed into various positions within the reactor tube 8 to create a variety of arrangements of stacks of catalyst carriers 10 within the reactor tube 8. For example, the support unit 20 support catalyst carriers 10 stacked above and/or below the support unit 20. The catalyst carriers 10 may form a stack that directly engages an upper or lower end of the support unit 20.

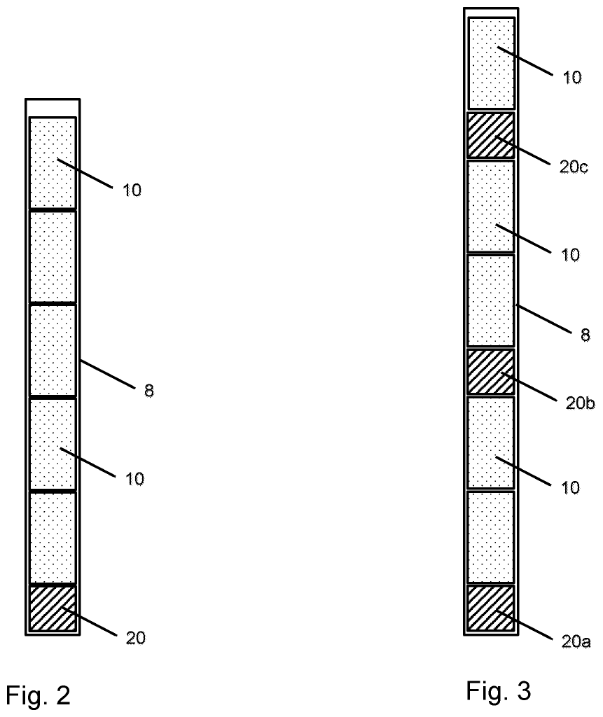

Schematic representations of two example arrangements are shown in FIGS. 2 and 3. For simplicity the figures only show a small number of catalyst carriers 10. In practice the reactor tube 8 will contain many more catalyst carriers 10.

In a first arrangement, shown in FIG. 2, the support unit 20 is configured to support a plurality of catalyst carriers 10 stacked above the support unit 20 in a single stack. The catalyst carriers 10 may form a stack of catalyst carriers 10 that directly engages an upper end of the support unit 20. Thus, in this example each reactor tube 8 may contain only a single support unit 20. Therefore, the complete stack of catalyst carriers 10 may be stacked upon one support unit 20. For example, 60, 70, 80 or more catalyst carriers 10 may be supported on top of one support unit 20. The support unit 20 may be located at a level of the lower tube sheet 7 to ensure that the lowermost catalyst carrier 10 in the bore is held within the heat-exchange zone 4.

In a second arrangement, shown in FIG. 3, a plurality of support units 20a-20c are provided within the reactor tube 8 with stacks of catalyst carriers 10 interposed between them. For example, a first support unit 20a may be installed at a level of the lower tube sheet 7 to ensure that the lowermost catalyst carrier 10 in the bore is held within the heat-exchange zone 4. A first subset of catalyst carriers 10 may be supported upon the first support unit 20a. A second support unit 20b may be installed above the first subset of catalyst carriers 10 with a second subset of catalyst carriers 10 supported thereupon. A third support unit 20c may be installed above the second subset of catalyst carriers 10 and so on. It will be appreciated that the first support unit 20a may be installed into the location shown in FIG. 3 by first inserting the first support unit 20a into the upper end of the reactor tube 8 and then pushing it part-way down the reactor tube 8 by inserting and pushing into the reactor tube the first subset of catalyst carriers 10. Inserting and pushing into the reactor tube the second support unit 20b and the second subset of catalyst carriers 10 and then the third support unit 20c will act to push the first support unit 20a successively further down the reactor tube 8. It is important to note that during this process the support units 20a-20c continuously support the catalyst carriers 10 that have been by that point inserted into the reactor tube 8.

The support unit 20 may be inserted into the reactor tube 8 on its own or together with one or more catalyst carriers 10.

Each subset of catalyst carriers 10 may contain up to 5, 10, 15 or more catalyst carriers 10. The reactor tube 8 may comprise 2 to 8 or more support units 20 and subsets of catalyst carriers by way of example.

At least one end of the support unit 20 may be configured to engage with one of the catalyst carriers 10 to maintain alignment of the catalyst carrier 10 in the bore of the reactor tube 8. For example, the upper end and/or lower end of the support unit 20 may be shaped to interface with a lower end and/or an upper end respectively of a catalyst carrier 10 to centre the catalyst carrier 10 within the bore.

The at least one engaging portion 24 may be adjustable for varying a magnitude of the frictional engagement of the support unit 20 with the inner surface of the reactor tube 8. Preferably, the at least one engaging portion 24 may be reversibly adjustable for selectively increasing and decreasing the frictional engagement of the support unit 20 with the inner surface of the reactor tube 8.

Adjustment of the at least one engaging portion 24 enables the support unit 20 to be tailored, e.g. calibrated, to the requirements of an individual reactor tube 8. Examples, include calibrating the frictional engagement to the inner diameter or ovality of the reactor tube 8. This calibration step may be carried out before or when first inserting the support unit 20 into the reactor tube 8.

Additionally or alternatively, the adjustment of the at least one engaging portion also enables the support unit 20 to have different levels of frictional engagement with the reactor tube 8 at different points in time throughout operation of the tubular reactor 1. For example, the frictional engagement may be reduced to permit easier insertion or removal of the support unit 20 into/from the reactor tube 8 and increased to provide increased security in the installed location when the tubular reactor 1 is running.

To facilitate this the at least one engaging portion 24 may be adjusted when the support unit 20 is installed in its installed position in the reactor tube 8. The at least one engaging portion 24 may be adjusted from a location above and/or below the support unit 20. The at least one engaging portion 24 may be adjusted using an adjustment tool that is applied to the support unit 20 via an end of the reactor tube 8.

The at least one engaging portion 24 may be configured to be pressed against the inner surface of the reactor tube 8.

The at least one engaging portion 24 may comprise 1, 2, 3, 4, 5, 6 or more engaging portions 24. It may comprise one or more pairs of engaging portions 24. Each pair may comprise opposed engaging portions 24 that extend outwardly from opposite sides of the support unit 20. The support unit 20 may be provided with two, four, six or more pairs of engaging portions 24.

The support unit 20 may comprise an adjustment mechanism for adjusting a length, an angle of projection, and/or a length of projection of the at least one engaging portion 24, and/or to adjust a force applied by the at least one engaging portion 24 against the inner surface of the reactor tube 8, and/or to adjust a surface area of engagement of the at least one engaging portion 24 against the inner surface of the reactor tube 8.

The at least one engaging portion 24 may comprise one or more arms, wings, flanges, rims, projections or skirts that project from a body of the support unit 20.

The support unit 20 may comprise a resilience for pressing the one or more arms, wings, flanges, rims or skirts against the inner surface of the reactor tube 8. The resilience may be a variable resistance, for example one or more spring elements.

The support unit 20 may comprise a mechanical or electrical mechanism for moving the at least one engaging portion 24. The mechanical or electrical mechanism may be configured to convert a linear or rotary action of an adjustment tool into a linear and/or a radial and/or an angular movement of the at least one engaging portion 24. The adjustment mechanism may comprise or consist of the mechanical mechanism.

Additionally or alternatively, the support unit 20 may comprise an hydraulic or pneumatic mechanism for moving the at least one engaging portion 24.

Each engaging portion 24 may comprise one or more arms, wings, flanges, rims, projections or skirts that project from a body of the support unit 20.

An example of a support unit 20 with one or more engaging portions 24 is shown in FIGS. 4 and 5. The support unit 20 may comprise a body 21 that may be cylindrical and may be tubular. An upper end of the support unit 20 may be provided with a socket 22 for receiving and centering a lower end of another catalyst carrier 10 located immediately above in the stack. The support unit 20 preferably does not have its own fluid seal with the reactor tube 8. Rather it is intended to be preferred that reactant(s) may freely pass around and/or through the support unit 20 when positioned in the bore of the reactor tube 8.

The support unit 20 of FIG. 4 comprises a plurality of engaging portions 24 located at a lower end of the body 21. The engaging portions 24 comprise a plurality of arms 25 that extend outwardly of the body 21. Distal ends of the arms are configured to engage against the inner surface of the reactor tube 8. In the illustrated example four arms 25 are provided, optionally spaced at 90° to each other.

A pair of arms 25 may be provided by a single resilient element. For example, a resilient strip of material may be mounted at or near its centre to the body 21 so that each end of the strip forms an arm 25.

The arms 25 may be formed from a resilient material having a suitable strength, for example carbon steel, aluminium, stainless steel, other such alloys.

In the illustrated example two strips have been mounted to the body 21 by means of a bolt 26 that is mounted through an aperture arranged at the centre, lengthwise, of each strip. The bolt 26 is coupled to a nut 27 that is fixedly attached to a lower end of the body 21.

The bolt 26 and the nut 27 form an adjustment mechanism. Clockwise rotation of the bolt 26 relative to the nut 27 forces the centres of the strips upwards towards the body 21. This movement causes the arms 25 to deflect outwardly causing the distal ends to be pressed more firmly against the inner surface of the reactor tube 8 to increase the magnitude of the frictional engagement of the support unit 20 with the inner surface.

The bolt 26 may be rotated using an adjustment tool in the form of a spanner or socket wrench. The spanner or socket wrench may be mounted on an extension arm if required to permit the bolt 26 to be reached when mounted within the bore of the reactor tube 8.

It will be appreciated that the resistance mechanism is reversibly adjustable, i.e. the bolt 26 may be rotated counter-clockwise to draw the arms 25 inwardly to reduce the frictional engagement of the support unit 20 with the inner surface of the reactor tube 8.

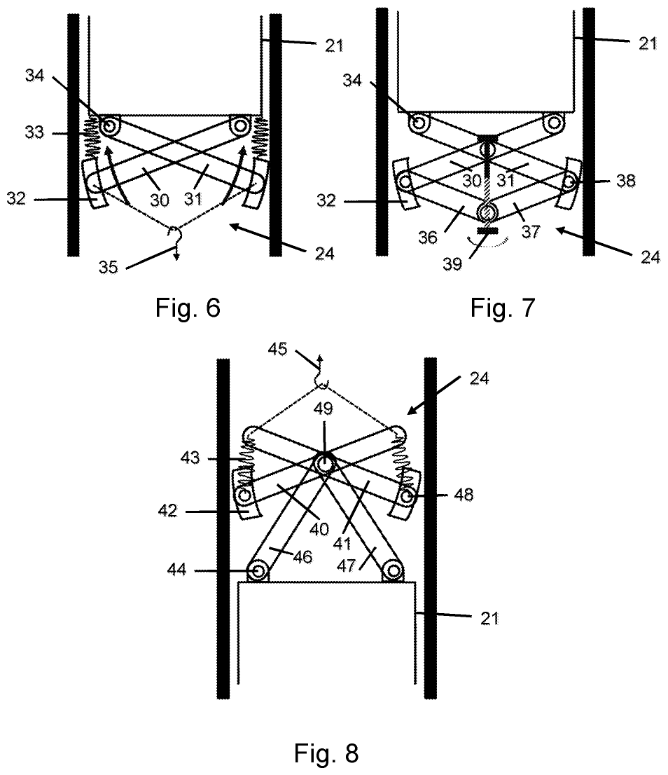

Another example of a support unit 20 with one or more engaging portions 24 is shown in FIG. 6. The support unit 20 comprises engaging portions 24 in the form of arms 30, 31 that are pivotally connected to the body 21 at pivot points 34. Each arm 30, 31 may have a shoe 32 at its distal end for engaging against an inner surface of the reactor tube 8. In the illustrated example two arms 30, 31 are provided, that extend in opposite directions and form a scissor-type arrangement. Each shoe 32, or each arm 30, 31, may be biased to engage the shoes 32 against the inner surface of the reactor tube 8. For example, as illustrated, the shoes 32 may be connected by springs 33 to the body 21 of the support unit 20. The springs 33 may act to pull the arms 30, 31 upwards towards the body 21 which will engage the shoes 32 against the inner surface due to the angle and length of the arm 30, 31. A release mechanism 35 may be provided to disengage (wholly or partially) the shoes 32 from the inner surface. For example, the release mechanism 35 may comprises a pull wire that extends between the shoes 32 or distal ends of the arms 30, 31. A tool may be coupled to the pull wire and the wire pulled downwards to release the support unit 20.

Another example of a support unit 20 with one or more engaging portions 24 is shown in FIG. 7. The support unit 20 is similar to that of FIG. 6 and comprises engaging portions 24 in the form of arms 30, 31, bearing shoes 32, that are pivotally connected to the body 21 at pivot points 34. It differs in that, first, an additional pair or arms 36, 37 are provided that are pivotally connected to each other and to the two shoes 32 (or distal ends of the arms 30, 31). Thus, a scissor-type arrangement is again achieved. Second, springs are not provided to bias the movement of the arms 30, 31. Rather a rotatable mechanism 39 is provided for adjusting the mutual angle of the arms 36, 37 relative to the arms 30, 31. In the illustrated example a bolt and nut device is coupled to the arms 30, 31 and the arms 36, 37. Operation of the bolt enables the arms 36, 37 to be moved up and down, respectively closer and further from the arms 30, 31, which facilitates movement of the shoes 32 into and out of engagement with the inner surface of the reactor tube 8.

Another example of a support unit 20 with one or more engaging portions 24 is shown in FIG. 8. The support unit 20 is similar to that of FIG. 6 and comprises engaging portions 24 in the form of arms 40, 41, bearing shoes 42, that are pivotally connected to the body 21 at pivot points 44. It differs in that, first, the arrangement is located at the upper end of the body 21. An additional pair of arms 46, 47 are provided to provide a stand-off for the pivot point 49 of the arms 40, 41. Secondly, each spring 43 extends from the shoe 42 of one of the arms 40, 41 to an opposite end of the other of the arms 40, 41. The release mechanism 45 functions in much the same way as in support unit of FIG. 6 except it is accessed by a tool from above and the pull wire is pulled upwards to release the support unit 20.

The support units 20 of the present disclosure may be used to support a variety of configurations of catalyst carriers 10. A catalyst carrier may generally comprise a container that is sized such that it is of a smaller dimension than the internal dimension of the reactor tube 8 into which it is to be placed in use. Typically, a seal will be provided that is sized such that it interacts to some extent with the inner wall of the bore of the reactor tube 8 when the catalyst carrier is in position within the reactor tube 8. Parameters such as container length and diameter may be selected to accommodate different reactions and configurations of reactor tube 8.

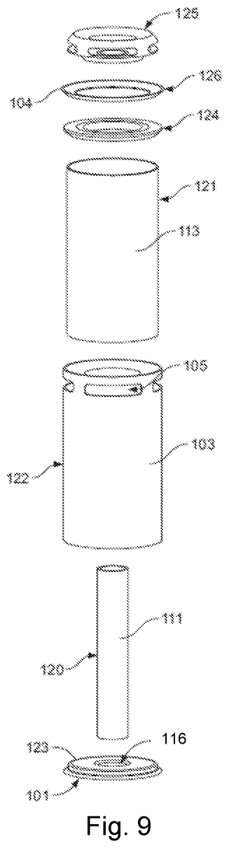

An example of a general type of a catalyst carrier 10 that may be used with the support unit(s) 20 in the tubular reactor 1 is shown, by way of example, in FIGS. 9, 10 and 11. However, it will be understood that the catalyst carriers 10 may take various forms. For example, as well as the examples described herein the catalyst carriers 10 may take other general forms including but not limited to those general forms disclosed in WO2011/048361, WO2012/136971 and WO2016/050520, the contents of which are herein incorporated by reference in their entirety. Known catalyst carriers, such as those described in WO2011/048361, WO2012/136971 and WO2016/050520 are typically configured to be self-supporting within the bore of the reactor tube. This was enabled by configuring the seal of the catalyst carrier to create a sufficient residual frictional engagement of the catalyst carrier with the inner surface of the reactor tube to maintain the position of the catalyst carrier within the reactor tube without external support.

According to the present disclosure, the use of the support unit(s) 20 enables the seal(s) of the catalyst carriers, such as those described in WO2011/048361, WO2012/136971 and WO2016/050520 or others, to be modified to produce non-self-supporting catalyst carriers that have a reduced residual frictional engagement with the inner surface of the bore of the reactor tube 8. However, the support unit(s) 20 may also be used with self-supporting catalyst carriers.

As shown in FIGS. 9, 10 and 11, the catalyst carrier 10 may comprise a container 100 for holding catalyst in use. The container 100 may generally have a bottom surface 101 that closes a lower end of the container 100 and a top surface 102 at an upper end of the container 100. A carrier outer wall 103 may extend from the bottom surface 101 to the top surface 102. A seal 104 may extend from the container 100 by a distance which extends beyond the carrier outer wall 103. The carrier outer wall 103 may have apertures 105 located below the seal 104.

In at least some embodiments the catalyst carrier 10 may more particularly comprise an annular container for holding catalyst in use. The annular container may comprise a perforated inner container wall 111 that defines an inner channel and a perforated outer container wall 113 that may be concentrically arranged about the perforated inner container wall 111. An annular top surface may close an upper end of the annular container and an annular bottom surface may close a lower end of the annular container. A lower end of the inner channel may be closed off by a channel end surface 116 except for one or more drain apertures that may be provided in the lower end of the inner channel. The channel end surface 116 may be formed integrally or separately to the inner container wall 111.

As shown in the exploded view of FIG. 9, the catalyst carrier 10 may be formed from a number of individual components that may be assembled together by any suitable means, including for example welding. In some embodiments such components may include a perforated inner tube 120, a perforated intermediate tube 121, an outer tube 122, a bottom cap 123, an annular top ring 124, a top cap 125 and an annular seal ring 126.

The catalyst carrier 10 may be formed of any suitable material. Such material will generally be selected to withstand the operating conditions of the reactor. Generally, the catalyst carrier will be fabricated from carbon steel, aluminium, stainless steel, other alloys or any material able to withstand the reaction conditions.

Suitable thicknesses for the components will generally be of the order of about 0.1 mm to about 1.0 mm, preferably of the order of about 0.3 mm to about 1.0 mm. In particular, the use of the support unit(s) 20 may enable the use of catalyst carriers 10 having a reduced crush strength where the thicknesses for the components will generally be of the order of about 0.5 mm or less.

The perforated inner tube 120 may comprise the perforated inner container wall 111. The perforated intermediate tube 121 may comprise the perforated outer container wall 113. The outer tube 122 may comprise the carrier outer wall 103 and define the apertures 105.

The bottom cap 123 may comprise the bottom surface 101 and/or the annular bottom surface. The bottom cap 123 may also extend across the perforated inner tube 120 to comprise the channel end surface 116. The annular top ring 124 and the top cap 125 may comprise the annular top surface 114 and may comprise at least part of the top surface 102. The annular seal ring 126 may comprise the seal 104.

The size of the perforations in the perforated inner tube 120 and the perforated intermediate tube 121 will be selected such as to allow uniform flow of reactant(s) and product(s) through the catalyst while maintaining the catalyst within the annular container. It will therefore be understood that their size will depend on the size of the catalyst particles being used. In an alternative arrangement the perforations may be sized such that they are larger but have a filter mesh covering the perforations to ensure catalyst is maintained within the annular container.

It will be understood that the perforations may be of any suitable configuration. Indeed, where a wall or tube is described as perforated, all that is required is that there is means to allow the reactants and products to pass through the walls or tubes.

The bottom surface 101, for example the bottom cap 123, may be shaped to engage with an upper end of another catalyst carrier 10 and/or the upper end of the support unit 20. For example, the bottom surface 101 may comprise an annular recess around the perforated inner tube 120. The top cap 125 may be shaped to engage in the annular recess of another catalyst carrier 10. For example, the top cap 125 may comprise an annular ring that upstands from an annular plug body 132. The annular ring may be shaped and sized to be received in the annular recess.

The bottom surface 101, for example the bottom cap 123 and/or channel end surface 116 may include one or more drain holes. Where one or more drain holes are present, they may be covered by a filter mesh.

The annular top ring 124 may be shaped and sized to engage in an upper end of the outer tube 122. The annular plug body 132 of the top cap 125 may have an outer diameter configured to engage with a central aperture of the annular top ring 124. Engagement of the top cap 125 with the annular top ring 124 may function to sandwich and retain the annular seal ring 126 in position.

The top cap 125 may comprise a central inlet 134 in the annular plug body 132 for enabling entry of liquids and gases into the upper end of the inner channel. The annular ring may comprise lateral apertures 133 than enable liquids and gases to reach the central inlet 134.

The carrier outer wall 103 may be smooth or it may be shaped. Suitable shapes include pleats, corrugations, and the like.

The apertures 105 in the carrier outer wall 103 may be of any configuration. In some embodiments, the apertures 105 may be holes or slots.

The seal 104 may be formed in any suitable manner. However, it will generally be sufficiently compressible to accommodate the smallest diameter of the reactor tube 8. The seal 104 will generally be a flexible, sliding seal. In some embodiments the seal 104 may comprise a deformable flange 140 extending from the carrier outer wall 103 or the top surface 102 of the catalyst carrier 10. The flange 140 may be sized to be larger than the internal diameter of the reactor tube 8 such that as the catalyst carrier 10 is inserted into the reactor tube 8 it is deformed to fit inside and interact with the reactor tube 8. Deformation of the seal 104 may promote a liquid-tight and/or gas-tight seal between the upper end of the catalyst carriers 10 and the inner surface of the reactor tube 8. The seal 104 may produce a fluid-tight seal with the inner surface of the bore of the reactor tube 8. Alternatively, it may be configured to permit a minor proportion of liquid and/or gas reactant(s) to bypass the seal 104. Optionally, the seal 104 may not provide any substantial physical support to maintain the axial position of the catalyst carrier 10 within the bore.

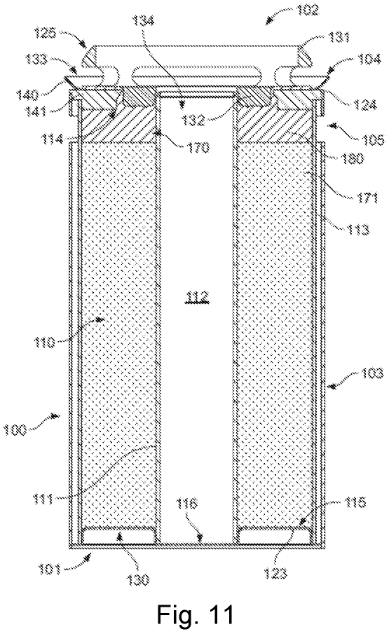

In the illustrated example of FIG. 11, the deformable flange 140 comprises an outer portion of the annular seal ring 126. An inner portion 141 of the annular seal ring 126 may define a clamping surface that is sandwiched and retained between the top cap 125 and the annular top ring 124. The deformable flange 140 may be angled relative to the inner portion 141. The deformable flange 140 may be angled towards the upper end of the catalyst carrier 10.

The carrier outer wall 103 may continue above the seal 104. Thus, the seal 104 may be located at the top of the catalyst carrier 10, optionally as part of the top surface 102, or it may be located at a suitable point on the carrier outer wall 103 provided that it is located above the apertures 105 in the carrier outer wall 103.

The catalyst carriers 10 may be configured to enable them to be attached together in a stacked arrangement. For example, adjacent catalyst carriers 10 may be engaged together by engagement of the one or more co-operating formations.

In some embodiments each catalyst carrier 10 may comprise upper co-operating formations provided on or towards the upper end of the container 100 and lower co-operating formations provided on or towards the lower end of the container 100.

Adjacent catalyst carriers 10 may be engaged together by engagement of the lower co-operating formations on one catalyst carrier 10 with the upper co-operating formations of an adjacent catalyst carrier 10.

The upper co-operating formations and the lower co-operating formations may be configured to be engaged and disengaged by relative rotational movement of the adjacent catalyst carriers 10. For example, the upper co-operating formations and the lower co-operating formations may take the form of bayonet fittings.

In some embodiments the upper co-operating formations are provided above the seal 104. For example, the upper co-operating formations may be provided on or as part of the annular ring and/or an upper portion of the carrier outer wall 103.

In use, the catalyst carriers 10 may be installed in the reactor tube 8 utilising the support unit(s) 20.

The first arrangement as shown schematically in FIG. 2 may be achieved, for example, by first inserting the support unit 20 into a first, preferably upper, end of the reactor tube 8 to create a frictional engagement between the engaging portions 24 of the support unit 20 and an inner surface of the reactor tube 8. The support unit 20 may be inserted by hand or by machine. The insertion may be carried out, or aided, by use of a ram. The ram may be manual ram operated by hand, or a powered ram operated, for example by a source or electrical, hydraulic or pneumatic power.

The frictional engagement with the reactor tube 8 prevents the support unit 20 moving down the reactor tube 8 in an uncontrolled manner. The magnitude of the frictional engagement may be adjusted before or when inserting the support unit 20 into the reactor tube 8 by adjusting the engaging portion(s) 24.

Such adjustment of the engaging portion(s) 24 may be used to calibrate the support unit 20 to a characteristic of the reactor tube 8, for example one or more of an inner diameter of the reactor tube 8, a surface roughness of the reactor tube 8, and an ovality of the reactor tube 8.

In addition, the adjustment may be used to calibrate the support unit 20 to the number of catalyst carriers 10 it will need in use to support in the reactor tube 8. For example, where the ‘stack’ of catalyst carriers 10 is 80 in number the engagement portion(s) 24 may be adjusted to create sufficient friction to support at least 80W (plus any required safety margin and the weight of the support unit), where W is the weight of one catalyst carrier 10.

This example assumes that the catalyst carriers 10 are entirely non-self-supporting—i.e. the support unit 20 supports the entire weight of the stack. Alternatively, the catalyst carriers 10 may be partially self-supporting, due to some friction achieved by engagement of the seal 104 with the reactor tube 8. In this case the frictional engagement of the support unit 20 would need to support less than 80W (but taking into account any required safety margin).

Catalyst carriers 10, either individual or in sets, may be inserted into the first end of the reactor tube 8 to push the support unit 20 progressively along the reactor tube 8 towards a second, preferably lower, end of the reactor tube 8 into the installed position shown in FIG. 2. As with the support units 20, the catalyst carriers 10 may be inserted manually and/or with the aid of tool such as a ram. Preferably the same ram may be used for both functions.

The engaging portion(s) 24 of the support unit 20 may also be adjusted while the support unit 20 is installed in its installed position in the reactor tube 8. For example, in the arrangement of FIG. 2, a tool may be inserted from below the support unit 20 (i.e. via the lower end of the reactor tube 8) to adjust the frictional engagement. This may be beneficial, for example, to increase the frictional engagement once the reactor tube 8 has been filled and the support unit 20 has been pushed down to the lower end so as ‘lock’ the support unit 20 in place.

The second arrangement as shown schematically in FIG. 3 may be achieved, for example, by first inserting the first support unit 20a into the first, preferably upper, end of the reactor tube 8 to create a frictional engagement in the same way as described above.

As above, the magnitude of the frictional engagement may be adjusted to calibrate the first support unit 20a to a characteristic of the reactor tube 8. Also, the engaging portion(s) 24 may be adjusted to calibrate the first support unit 20a to the number of catalyst carriers 10 it will need in use to support in the reactor tube 8. In this case, the number of catalyst carriers 10 to be supported are not the whole stack but only those immediately above the first support unit 20a and below the second support unit 20b—in the illustrated example this is two catalyst carriers 10. Thus, the magnitude of the frictional engagement of the first support unit 20a may only need to be 2W (plus any required safety margin and the weight of the first support unit), where W is the weight of one catalyst carrier 10.

Next two catalyst carriers 10, individually or as a pair, may be inserted to push the first support unit 20a part way along the reactor tube 8.

The process is then repeated with the second support unit 20b, another pair of catalyst carriers 10 and the third support unit 20c.

As each subset of support unit 20a-c and its associated catalyst carriers 10 in inserted, the total force required to push the entire stack along the reactor tube 8 will increase. However, the use of a plurality of support units 20 in a single reactor tube 8 may be used to reduce the maximum insertion force required compared to fill the reactor tube 8 compared to the use of a single support unit 20 as illustrated in FIG. 2.

Once the reactor tubes 8 are all filled the tubular reactor 1 may be operated. In operation, for example with downflow, reactant(s) flow downwardly through each reactor tube 8. The reactant(s) are directed to flow through the catalyst carriers 10 to contact the catalyst contained therein. Since the support units 20 do not have a fluid seal the reactant(s) may flow through and/or around the support units 20 substantially unhindered. The support units 20 preferably do not contain any catalyst.

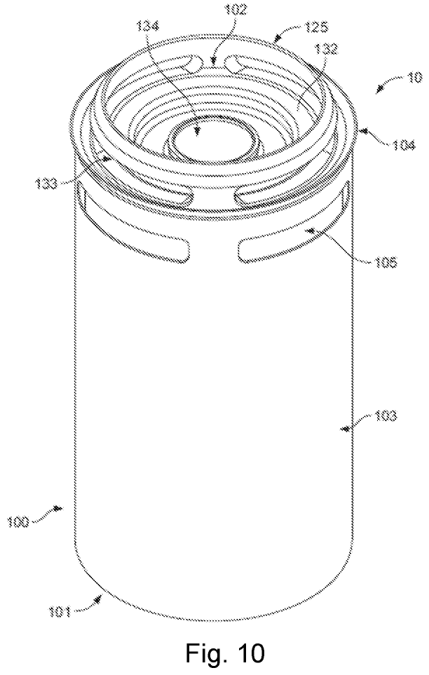

In an example of the flow, using the example catalyst carriers 10 shown in FIGS. 9 and 10, the reactant(s) first contact the top surface 102 of the uppermost catalyst carrier 10 in the stacked formation. The seal 104 of the catalyst carrier 10 blocks the passage of the reactant(s) around the side of the catalyst carrier 10. Therefore, the top surface 102 directs the reactants inwardly through the lateral apertures 133 into the central inlet 134 at the upper end of the inner channel within the inner container wall 111 defined by the perforated inner tube 120.

The reactant(s) then enters the annular container 110 through the perforated inner tube 120 and then passes radially through the catalyst bed towards the outer container wall 113 defined by the perforated intermediate tube 121. During this passage the reactant(s) contact the catalyst and reaction occurs to form product(s).

Unreacted reactant(s) and product(s) then flow out of the annular container 110 through the perforated intermediate tube 121. The carrier outer wall 103 defined by the outer tube 122 then directs reactant(s) and product(s) upwardly between the inner surface of the carrier outer wall 103 and the perforated intermediate tube 121 until they reach the apertures 105 in the carrier outer wall 103. They are then directed through the apertures 105 and flow downwardly between the outer surface of the carrier outer wall 103 and the inner surface of the reactor tube 8 where heat transfer takes place.

The unreacted reactant(s) and product(s) may then contact the top surface 102 of the underlying catalyst carrier 10 in the stacked formation and the process described above may repeat. This pattern may repeat as the reactant(s) and product(s) pass down the stacked formation until they are collected out of the lower end of the reactor tube 8.

Some of the products, especially liquid products, may drain out of the inner channel through the drain hole provided in the channel end surface 116 into the inner channel of the underlying catalyst carrier 10. Such products may then continue to drain down the stacked formation of the catalyst carriers 10 and be collected out of the lower end of the reactor tubes 8.

When it is required to uninstall the catalyst carriers 10, for example for maintenance of the tubular reactor 1 or replacement of the catalyst carriers 10, the support unit(s) 20 may be removed from the reactor tubes 8 by pushing them out along with the catalyst carriers 10.

Optionally, the magnitude of the resistance of the engaging portion(s) 24 can first be reduced to allow easier removal. For example, in the arrangement of FIG. 2, a tool may be inserted through the lower end of the reactor tube 8 to operate the adjustment mechanism to decrease the frictional engagement of, for example, the arms 25 with the inner surface of the reactor tube 8. Thereafter the support unit(s) 20 and the catalyst carriers 10 may be removed.

The catalyst carriers 10 may be removed from the lower end of each reactor tube 8. The catalyst carriers 10 may freely slide out of the reactor tube 8 under the action of gravity where they are non-self-supporting. Alternatively they may be pushed out, for example by insertion of additional elements into the upper end of the reactor tube 8.

Further aspects and embodiments of the present disclosure are set out in the following clauses:

### CLAUSES

A1. A method of installing catalyst carriers into a reactor tube of a tubular reactor, the tubular reactor being of a type comprising a plurality of reactor tubes that extend between an upper tube sheet and a lower tube sheet, with a heat-exchange zone being provided between the upper tube sheet and the lower tube sheet;
the method comprising the steps of:
i) providing a plurality of catalyst carriers;
ii) providing a support unit comprising at least one engaging portion for engaging an inner surface of the reactor tube;
iii) inserting the support unit into a first, preferably upper, end of the reactor tube to create a frictional engagement between the at least one engaging portion of the support unit and an inner surface of the reactor tube;
iv) inserting catalyst carriers into the first end of the reactor tube to push the support unit along the reactor tube towards a second, preferably lower, end of the reactor tube into an installed position;
wherein a magnitude of the frictional engagement of the at least one engaging portion of the support unit enables the support unit to support a static load of two or more catalyst carriers so as to hold two or more catalyst carriers in place within the reactor tube when additional catalyst carriers are not being inserted into the first end of the reactor tube.

A2. The method of clause A1, wherein the magnitude of the frictional engagement is selected to enable the support unit to support the static load of three or more, optionally five or more, optionally ten or more, optionally twenty or more, optionally fifty or more catalyst carriers, so as to hold three or more, optionally five or more, optionally ten or more, optionally twenty or more, optionally fifty or more catalyst carriers in place within the reactor tube when additional catalyst carriers are not being inserted into the first end of the reactor tube.

A3. The method of clause A1 or clause A2, wherein the magnitude of the frictional engagement is selected to enable the support unit to slide along the reactor tube under a dynamic loading imparted on the support unit via the catalyst carriers as additional catalyst carriers are inserted into the first end of the reactor tube.

A4. The method of any preceding clause, wherein a magnitude of a frictional engagement of each individual catalyst carrier with the reactor tube, when inserted in the reactor tube, is less than a weight of that catalyst carrier such that the catalyst carrier will slide down the reactor tube under its own weight unless supported by an external object.

A5. The method of any preceding clause, wherein the support unit is pushed along the reactor tube into its installed position that is in proximity with the second end of the reactor tube, and preferably level with the lower tube sheet.

A6. The method of any preceding clause, wherein the method comprises inserting a single support unit in the reactor tube and pushing the single support unit towards the second end of the reactor tube using a single stack of catalyst carriers that are inserted individually or in sets into the first end of the reactor tube; and optionally wherein the single stack of catalyst carriers extends from the single support unit to, or into proximity with, the first end of the reactor tube.

A7. The method of any one of clauses A1 to A5, wherein the method comprises:
a) inserting a first support unit in the reactor tube and pushing the first support unit towards the second end of the reactor tube using a first stack of one or more catalyst carriers that are inserted individually or in sets into the first end of the reactor tube;
b) inserting a second support unit in the reactor tube and pushing the second support unit, the first stack of one or more catalyst carriers and the first support unit towards the second end of the reactor tube using a second stack of one or more catalyst carriers that are inserted individually or in sets into the first end of the reactor tube.

A8. The method of clause A7, further comprising, likewise to step b), inserting third, fourth or greater numbers of support units by use of third, fourth or greater numbers of stacks of one or more catalyst carriers.

A9. The method of any preceding clause, wherein the magnitude of the frictional engagement of the at least one engaging portion of the support unit with the inner surface of the reactor tube can be varied by adjustment of the at least one engaging portion of the support unit.

A10. The method of clause A9, wherein adjustment of the at least one engaging portion of the support unit is carried out before or during insertion of the support into the reactor tube; and optionally wherein the at least one engaging portion is adjusted to calibrate the magnitude of the frictional engagement to a characteristic of the reactor tube.

A11. The method of clause A9, wherein adjustment of the at least one engaging portion of the support unit is carried out when the support unit is installed in its installed position in the reactor tube; and optionally wherein the at least one engaging portion is adjusted to calibrate the magnitude of the frictional engagement to a characteristic of the reactor tube.

A12. The method of clause A9 or clause A10, wherein the characteristic of the reactor tube is one or more of an inner diameter of the reactor tube, a surface roughness of the reactor tube, and an ovality of the reactor tube.

A13. The method of any one of clauses A9 to A12, wherein varying the magnitude of the frictional engagement is carried out from a location above and/or below the support unit.

A14. The method of any one of clauses A9 to A13, wherein varying the magnitude of the frictional engagement is carried out using an adjustment tool that is applied to the support unit via the first end and/or the second end of the reactor tube.

A15. The method of any preceding clause, further comprising varying the magnitude of the frictional engagement of the support unit with the inner surface of the reactor tube to lock the support unit relative to the reactor tube.

A16. The method of any preceding clause, wherein the or each support unit does not contain any catalyst material.

A17. The method of any preceding clause, further comprising uninstalling the catalyst carriers from the reactor tube by:
v) removing the or each support unit from the reactor tube;
vi) sliding the catalyst carriers out of the reactor tube, preferably solely under the action of gravity.

A18. The method of clause A17, wherein the or each support unit is removed from one end of the reactor tube by being pushed out using one or more additional catalyst carriers that are inserted into an opposite end of the reactor tube.

A19. The method of clause A17, wherein the or each support unit is removed from the reactor tube by decreasing the magnitude of the frictional engagement of the at least one engaging portion of the support unit with the inner surface of the reactor tube and allowing the support unit to slide out of the reactor tube, preferably solely under the action of gravity.

B1. A support unit for a reactor tube of a tubular reactor, the tubular reactor being of a type comprising a plurality of reactor tubes that extend between an upper tube sheet and a lower tube sheet, with a heat-exchange zone being provided between the upper tube sheet and the second tube sheet;
the support unit being installable within the reactor tube together with a plurality of catalyst carriers;
the support unit comprising at least one engaging portion for engaging an inner surface of the reactor tube to create a frictional engagement between the support unit and the reactor tube;
the magnitude of the frictional engagement being sufficient for the support unit to support a static load of two or more catalyst carriers so as to hold two or more catalyst carriers in place within the reactor tube.

B2. The support unit of clause B1, wherein the magnitude of the frictional engagement is sufficient for the support unit to support the static load of three or more, optionally five or more, optionally ten or more, optionally twenty or more, optionally fifty or more catalyst carriers, so as to hold three or more, optionally five or more, optionally ten or more, optionally twenty or more, optionally fifty or more catalyst carriers in place within the reactor tube.

B3. The support unit of clause B1 or clause B2, wherein the support unit is configured to support a plurality of catalyst carriers stacked above and/or below the support unit; optionally wherein the plurality of catalyst carriers form a stack of catalyst carriers that directly engages an upper or lower end of the support unit.

B4. The support unit of any one of clauses B1 to B3, wherein the at least one engaging portion is adjustable for varying a magnitude of the frictional engagement of the support unit with the inner surface of the reactor tube.

B5. The support unit of any one of clauses B1 to B4, wherein the at least one engaging portion is reversibly adjustable for selectively increasing and decreasing the frictional engagement of the support unit with the inner surface of the reactor tube.

B6. The support unit of any one of clauses B1 to B5, wherein the at least one engaging portion is configured to be adjustable before or during insertion of the support unit into the reactor tube.

B7. The support unit of any one of clauses B1 to B5, wherein the at least one engaging portion is configured to be adjustable when the support unit is installed in its installed position in the reactor tube.

B8. The support unit of any one of clauses B1 to B7, wherein the at least one engaging portion is configured to be adjustable from a location above and/or below the support unit.

B9. The support unit of any one of clauses B1 to B8, wherein the at least one engaging portion comprises an adjustment mechanism that is configured to be operated by an adjustment tool that is applied to the support unit via an end of the reactor tube.

B10. The support unit of any one of clauses B1 to B9, wherein the at least one engaging portion is configured to be pressed against the inner surface of the reactor tube.

B11. The support unit of any one of clauses B1 to B10, wherein the at least one engaging portion comprises an adjustment mechanism that is operable to adjust a length, an angle of projection, and/or a length of projection of the at least one engaging portion, and/or to adjust a force applied by the at least one engaging portion against the inner surface of the reactor tube, and/or to adjust a surface area of engagement of the at least one engaging portion against the inner surface of the reactor tube.

B12. The support unit of any one of clauses B1 to B11, wherein the at least one engaging portion comprises one or more arms, wings, flanges, rims, projections or skirts that project from a body of the support unit.

B13. The support unit of clause B12, wherein the support unit comprises a resilience for pressing the one or more arms, wings, flanges, rims, projections or skirts against the inner surface of the bore of the reactor tube; optionally wherein the resilience is a variable resistance; optionally wherein the resilience comprises one or more spring elements.

B14. The support unit of any one of clauses B1 to B13, wherein the support unit comprises a mechanical mechanism for moving the at least one engaging portion; and optionally the mechanical mechanism is configured to convert a linear or rotary action of an adjustment tool into a linear and/or a radial and/or an angular movement of the at least one engaging portion.

B15. The support unit of any one of clauses B1 to B14, wherein at least one end of the support unit is configured to engage with one of the catalyst carriers to maintain alignment of the catalyst carriers in the reactor tube.

B16. The support unit of any one of clauses B1 to B15, wherein the or each support unit does not contain any catalyst material.

C1. A support unit for a reactor tube of a tubular reactor, the tubular reactor being of a type comprising a plurality of reactor tubes that extend between an upper tube sheet and a lower tube sheet, with a heat-exchange zone being provided between the upper tube sheet and the second tube sheet;
the support unit being installable within the reactor tube together with a plurality of catalyst carriers;
the support unit comprising at least one engaging portion for engaging an inner surface of the reactor tube to create a frictional engagement between the support unit and the reactor tube;
wherein the at least one engaging portion is adjustable for varying a magnitude of the frictional engagement of the support unit with the inner surface of the reactor tube.

C2. The support unit of clause C1, wherein the at least one engaging portion is reversibly adjustable for selectively increasing and decreasing the frictional engagement of the support unit with the inner surface of the reactor tube.

C3. The support unit of clause C1 or clause C2, wherein the at least one engaging portion is configured to be pressed against the inner surface of the reactor tube.

C4. The support unit of any one of clauses C1 to C3, wherein the at least one engaging portion comprises an adjustment mechanism that is operable to adjust a length, an angle of projection, and/or a length of projection of the at least one engaging portion, and/or to adjust a force applied by the at least one engaging portion against the inner surface of the reactor tube, and/or to adjust a surface area of engagement of the at least one engaging portion against the inner surface of the reactor tube.

C5. The support unit of any one of clauses C1 to C4, wherein the at least one engaging portion comprises one or more arms, wings, flanges, rims, projections or skirts that project from a body of the support unit.

C6. The support unit of clause C5, wherein the support unit comprises a resilience for pressing the one or more arms, wings, flanges, rims, projections or skirts against the inner surface of the bore of the reactor tube; optionally wherein the resilience is a variable resistance; optionally wherein the resilience comprises one or more spring elements.

C7. The support unit of any one of clauses C1 to C6, wherein the support unit comprises a mechanical mechanism for moving the at least one engaging portion; and optionally the mechanical mechanism is configured to convert a linear or rotary action of an adjustment tool into a linear and/or a radial and/or an angular movement of the at least one engaging portion.

D1. A tubular reactor comprising a plurality of reactor tubes that extend between an upper tube sheet and a lower tube sheet, with a heat-exchange zone being provided between the upper tube sheet and the lower tube sheet, the or each reactor tube containing:
i) one or more support units that each comprise at least one engaging portion frictionally engaging an inner surface of the reactor tube; and
iii) one or more stacks of catalyst carriers that are supported in place by the one or more support units.

D2. The tubular reactor of clause D1, wherein each support unit supports two or more catalyst carriers, optionally three or more, optionally five or more, optionally ten or more, optionally twenty or more, optionally fifty or more catalyst carriers.

D3. The tubular reactor of clause D1 or clause D2, wherein a frictional engagement of each individual catalyst carrier with the reactor tube in which it is contained is less than the weight of that catalyst carrier.

D4. The tubular reactor of any one of clauses D1 to D3, wherein the or each reactor tube contains two or more support units.

D5. The tubular reactor of any one of clauses D1 to D4, wherein the at least one engaging portion of the one or more support units has been adjusted to vary a magnitude of the frictional engagement with the inner surface of the reactor tube in which it is contained.

D6. The tubular reactor of clause D5, wherein the at least one engaging portion of the one or more support units has been adjusted to calibrate the magnitude of the frictional engagement to a characteristic of the reactor tube, for example an inner diameter of the reactor tube, a surface roughness of the reactor tube, and/or an ovality of the reactor tube.

D7. The tubular reactor of any one of clauses D1 to D6, wherein the or each support unit is as set out in any one of clauses B1 to B16 or C1 to C7.

E1. A kit of parts for installation in a reactor tube of a tubular reactor being of a type comprising a plurality of reactor tubes that extend between an upper tube sheet and a lower tube sheet, with a heat-exchange zone being provided between the upper tube sheet and the lower tube sheet, the kit of parts comprising one or more support units and a plurality of catalyst carriers;
wherein the one or more support units are installable within the reactor tube and each support unit comprises at least one engaging portion for engaging an inner surface of the reactor tube to create a frictional engagement between the support unit and the reactor tube of a magnitude sufficient to support the weight of two or more of the catalyst carriers; and
wherein the catalyst carriers are installable within the reactor tube and each catalyst carrier comprises a seal for engaging the inner surface of the reactor tube to produce a frictional engagement between the catalyst carrier and the reactor tube that is insufficient to support the weight of the catalyst carrier within the reactor tube.

E2. The kit of parts of clause E1, wherein the at least one engaging portion of each support unit creates a frictional engagement between the support unit and the reactor tube of a magnitude sufficient to support the weight of three or more, optionally five or more, optionally ten or more, optionally twenty or more, optionally fifty or more catalyst carriers.

E3. The kit of parts of clause E1 or clause E2, wherein the one or more support units do not contain any catalyst material and the catalyst carriers contain a catalyst material.

E4. The kit of parts of any one of clauses E1 to E3 comprising 1 to 20 support units and 20 to 200 catalyst carriers.

1. A method of installing catalyst carriers into a reactor tube of a tubular reactor, the tubular reactor being of a type comprising a plurality of reactor tubes that extend between an upper tube sheet and a lower tube sheet, with a heat-exchange zone being provided between the upper tube sheet and the lower tube sheet;
the method comprising the steps of:
i) providing a plurality of catalyst carriers;
ii) providing a support unit comprising at least one engaging portion for engaging an inner surface of the reactor tube;
iii) inserting the support unit into a first, preferably upper, end of the reactor tube to create a frictional engagement between the at least one engaging portion of the support unit and an inner surface of the reactor tube; and
iv) inserting catalyst carriers into the first end of the reactor tube to push the support unit along the reactor tube towards a second, preferably lower, end of the reactor tube into an installed position;
wherein a magnitude of the frictional engagement of the at least one engaging portion of the support unit enables the support unit to support a static load of two or more catalyst carriers so as to hold two or more catalyst carriers in place within the reactor tube when additional catalyst carriers are not being inserted into the first end of the reactor tube.

2. The method of claim 1, wherein the magnitude of the frictional engagement is selected to enable the support unit to support the static load of three or more, optionally five or more, optionally ten or more, optionally twenty or more, optionally fifty or more catalyst carriers, so as to hold three or more, optionally five or more, optionally ten or more, optionally twenty or more, optionally fifty or more catalyst carriers in place within the reactor tube when additional catalyst carriers are not being inserted into the first end of the reactor tube.

3. The method of claim 1, wherein a magnitude of a frictional engagement of each individual catalyst carrier with the reactor tube, when inserted in the reactor tube, is less than a weight of that catalyst carrier such that the catalyst carrier will slide down the reactor tube under its own weight unless supported by an external object.

4. The method of claim 1, wherein the method comprises:
i) inserting a single support unit in the reactor tube and pushing the single support unit towards the second end of the reactor tube using a single stack of catalyst carriers that are inserted individually or in sets into the first end of the reactor tube; and optionally wherein the single stack of catalyst carriers extends from the single support unit to, or into proximity with, the first end of the reactor tube;
or
ii) a) inserting a first support unit in the reactor tube and pushing the first support unit towards the second end of the reactor tube using a first stack of one or more catalyst carriers that are inserted individually or in sets into the first end of the reactor tube; and
b) inserting a second support unit in the reactor tube and pushing the second support unit, the first stack of one or more catalyst carriers and the first support unit towards the second end of the reactor tube using a second stack of one or more catalyst carriers that are inserted individually or in sets into the first end of the reactor tube.

5. The method of claim 1, wherein the magnitude of the frictional engagement of the at least one engaging portion of the support unit with the inner surface of the reactor tube can be varied by adjustment of the at least one engaging portion of the support unit.

6. The method of claim 5,
wherein adjustment of the at least one engaging portion of the support unit is carried out before or during insertion of the support into the reactor tube; and optionally wherein the at least one engaging portion is adjusted to calibrate the magnitude of the frictional engagement to a characteristic of the reactor tube;
or
wherein adjustment of the at least one engaging portion of the support unit is carried out when the support unit is installed in its installed position in the reactor tube; and optionally wherein the at least one engaging portion is adjusted to calibrate the magnitude of the frictional engagement to a characteristic of the reactor tube.

7. The method of claim 5, wherein varying the magnitude of the frictional engagement is carried out using an adjustment tool that is applied to the support unit via the first end and/or the second end of the reactor tube.

8. The method of claim 1, wherein the or each support unit does not contain any catalyst material.

9. The method of claim 1, further comprising uninstalling the catalyst carriers from the reactor tube by:
v) removing the or each support unit from the reactor tube;
vi) sliding the catalyst carriers out of the reactor tube, preferably solely under the action of gravity.

10. The method of claim 9,
wherein the or each support unit is removed from one end of the reactor tube by being pushed out using one or more additional catalyst carriers that are inserted into an opposite end of the reactor tube;
or
wherein the or each support unit is removed from the reactor tube by decreasing the magnitude of the frictional engagement of the at least one engaging portion of the support unit with the inner surface of the reactor tube and allowing the support unit to slide out of the reactor tube, preferably solely under the action of gravity.

11. A support unit for a reactor tube of a tubular reactor, the tubular reactor being of a type comprising a plurality of reactor tubes that extend between an upper tube sheet and a lower tube sheet, with a heat-exchange zone being provided between the upper tube sheet and the second tube sheet;
the support unit being installable within the reactor tube together with a plurality of catalyst carriers;
the support unit comprising at least one engaging portion for engaging an inner surface of the reactor tube to create a frictional engagement between the support unit and the reactor tube;
the magnitude of the frictional engagement being sufficient for the support unit to support a static load of two or more catalyst carriers so as to hold two or more catalyst carriers in place within the reactor tube.

12. The support unit of claim 11, wherein the magnitude of the frictional engagement is sufficient for the support unit to support the static load of three or more, optionally five or more, optionally ten or more, optionally twenty or more, optionally fifty or more catalyst carriers, so as to hold three or more, optionally five or more, optionally ten or more, optionally twenty or more, optionally fifty or more catalyst carriers in place within the reactor tube.

13. The support unit of claim 11, wherein the at least one engaging portion is reversibly adjustable for selectively increasing and decreasing the frictional engagement of the support unit with the inner surface of the reactor tube.

14. The support unit of claim 11, wherein the at least one engaging portion comprises an adjustment mechanism that is operable to adjust a length, an angle of projection, and/or a length of projection of the at least one engaging portion, and/or to adjust a force applied by the at least one engaging portion against the inner surface of the reactor tube, and/or to adjust a surface area of engagement of the at least one engaging portion against the inner surface of the reactor tube.

15. The support unit of claim 11, wherein the at least one engaging portion comprises one or more arms, wings, flanges, rims, projections or skirts that project from a body of the support unit.

16. The support unit of claim 11, wherein the or each support unit does not contain any catalyst material.

17. A support unit for a reactor tube of a tubular reactor, the tubular reactor being of a type comprising a plurality of reactor tubes that extend between an upper tube sheet and a lower tube sheet, with a heat-exchange zone being provided between the upper tube sheet and the second tube sheet;
the support unit being installable within the reactor tube together with a plurality of catalyst carriers;
the support unit comprising at least one engaging portion for engaging an inner surface of the reactor tube to create a frictional engagement between the support unit and the reactor tube;
wherein the at least one engaging portion is adjustable for varying a magnitude of the frictional engagement of the support unit with the inner surface of the reactor tube.

18. The support unit of claim 17, wherein the at least one engaging portion is reversibly adjustable for selectively increasing and decreasing the frictional engagement of the support unit with the inner surface of the reactor tube.

19. A tubular reactor comprising a plurality of reactor tubes that extend between an upper tube sheet and a lower tube sheet, with a heat-exchange zone being provided between the upper tube sheet and the lower tube sheet, the or each reactor tube containing:
i) one or more support units that each comprise at least one engaging portion frictionally engaging an inner surface of the reactor tube; and
iii) one or more stacks of catalyst carriers that are supported in place by the one or more support units.

20. The tubular reactor of claim 19, wherein each support unit supports two or more catalyst carriers, optionally three or more, optionally five or more, optionally ten or more, optionally twenty or more, optionally fifty or more catalyst carriers.

21. The tubular reactor of claim 19, wherein a frictional engagement of each individual catalyst carrier with the reactor tube in which it is contained is less than the weight of that catalyst carrier.

22. The tubular reactor of claim 19, wherein the or each reactor tube contains two or more support units.

23. The tubular reactor of claim 19, wherein the at least one engaging portion of the one or more support units has been adjusted to vary a magnitude of the frictional engagement with the inner surface of the reactor tube in which it is contained.

24. A kit of parts for installation in a reactor tube of a tubular reactor being of a type comprising a plurality of reactor tubes that extend between an upper tube sheet and a lower tube sheet, with a heat-exchange zone being provided between the upper tube sheet and the lower tube sheet, the kit of parts comprising one or more support units and a plurality of catalyst carriers;
wherein the one or more support units are installable within the reactor tube and each support unit comprises at least one engaging portion for engaging an inner surface of the reactor tube to create a frictional engagement between the support unit and the reactor tube of a magnitude sufficient to support the weight of two or more of the catalyst carriers; and
wherein the catalyst carriers are installable within the reactor tube and each catalyst carrier comprises a seal for engaging the inner surface of the reactor tube to produce a frictional engagement between the catalyst carrier and the reactor tube that is insufficient to support the weight of the catalyst carrier within the reactor tube.

25. The kit of parts of claim 24, wherein the one or more support units do not contain any catalyst material and the catalyst carriers contain a catalyst material.
